(19) United States
(12) Patent Application Publication
(10) Pub. No.: US 2025/0052069 A1
(43) Pub. Date: Feb. 13, 2025

(54) OUTER WALL AND BUILDING

(71) Applicant: Sekisui House, Ltd., Osaka-Shi, Osaka (JP)

(72) Inventors: Takeshi Takagi, Osaka-shi (JP); Masayuki Ogawa, Osaka-shi (JP); Tomoya Hatae, Osaka-shi (JP); Yuusaku Takeda, Osaka-shi (JP)

(73) Assignee: Sekisui House, Ltd., Osaka-Shi, Osaka (JP)

(21) Appl. No.: 18/720,378

(22) PCT Filed: Dec. 22, 2021
(86) PCT No.: PCT/JP2021/047554

§ 371 Date: Jun. 14, 2024

(51) Int. Cl. E04F 13/08; E04F 13/14

(52) U.S. Cl. CPC E04F 13/0875; E04F 13/0846; E04F 13/141

(57) ABSTRACT

An outer wall of a building includes a plurality of spaced apart vertical frames, an outer board provided on the outer surfaces of the plurality of vertical frames, an outer insulating material provided on the outer surface of the outer board, and outer wall panels provided on the vertical frames with at least one support member therebetween. The support member is fixed to the vertical frames via the outer board. The outer wall panels are fixed to the support member via support metal fixtures.

### TECHNICAL FIELD

The present disclosure relates to an outer wall and a building.

### BACKGROUND ART

A cladding panel is known as a member forming an outer wall of a building (for example, Patent Literature 1). The cladding panel has a thermal insulation layer. The cladding panel is fixed to a frame of the building. Tiles are attached to the fixed cladding panel with a spacer between the tiles and the fixed cladding panel.

### CITATION LIST

### Patent Literature

Patent Literature 1: U.S. Patent Application Publication No. US 2010/0,229,484 A

### SUMMARY OF INVENTION

### Technical Problem

A thermal insulation layer has a lower strength than wood or metal frames. For this reason, there is room for improvement in the strength of an outer wall having thermal insulating properties.

### Solution to Problem

(1) To achieve the foregoing objective, an outer wall of a building includes multiple vertical frames arranged at intervals, an outer board provided on outer surfaces of the vertical frames, an outer thermal insulating material provided on an outer surface of the outer board, and an outer wall panel provided on the vertical frame with at least one support member between the outer wall panel and the vertical frame. The support member is fixed to the vertical frame with the outer board between the support member and the vertical frame. The outer wall panel is fixed to the support member with a support bracket. According to this configuration, the support member is fixed to the vertical frame. As a result, the outer wall is made less likely to deteriorate.

(2) In the outer wall of item (1), an inner board provided on inner surfaces of the vertical frames, and an inner thermal insulating material provided between the inner board and the outer board. According to this configuration, the thermal insulating properties of the outer wall is improved by the inner thermal insulating material.

(3) In the outer wall of item (1) or (2), the support member extends along the vertical frame. According to this configuration, the vertical frame is reinforced.

(4) In the outer wall of item (3), the support member is fixed along the vertical frame with the outer board between the support member and the vertical frame, and the outer thermal insulating material is disposed between the support members which are disposed at intervals.

According to this configuration, the support member is firmly fixed to the vertical frame.

(5) In the outer wall of item (3), the outer thermal insulating material is provided so as to be in contact with the outer board, and the support member is fixed to the vertical frame with the outer board and the outer thermal insulating material between the support member and vertical frame. According to this configuration, the thermal insulation layer having a small gap is formed by the outer thermal insulating material. Therefore, the thermal insulating properties of the outer wall are improved.

(6) In the outer wall of any one of items (3) to (5), the support member is provided on each of the vertical frames, and the outer wall panel is disposed so as to extend over the support members disposed at intervals, and is supported by the support brackets respectively provided on the support members. According to this configuration, the support of the outer wall panel is stabilized.

(7) To achieve the foregoing objective, a building includes the outer wall of any one of items (1) to (6). According to this configuration, the building has the outer wall which resists deterioration. Therefore, it is possible to provide a building that has thermal insulating properties and resists deterioration.

### Advantageous Effects of Invention

According to the outer wall and the building of the present disclosure, it is possible to make the outer wall and the building less likely to deteriorate.

### BRIEF DESCRIPTION OF DRAWINGS

FIG. 1 is a perspective view of a building.

FIG. 2 is a view illustrating a structure of an outer wall.

FIG. 3 is a perspective view of a support bracket.

FIG. 4 is a cross-sectional view of an outer wall illustrating a support structure of an outer wall panel.

FIG. 5 is a front view of an outer wall, illustrating an arrangement of the support bracket.

FIG. 6 is a cross-sectional view of an outer wall taken along line A-A in FIG. 5 for a first example of the outer wall.

FIG. 7 is a cross-sectional view of an outer wall taken along line B-B in FIG. 5 for a first example of the outer wall.

FIG. 8 is a cross-sectional view of an outer wall illustrating a fixing structure of a support member in the first example of the outer wall.

FIG. 9 is a cross-sectional view of an outer wall illustrating an arrangement relationship between the support member and an outer thermal insulating material in the first example of the outer wall.

FIG. 10 is a cross-sectional view of an outer wall taken along the line A-A in FIG. 5 for a second example of the outer wall.

FIG. 11 is a cross-sectional view of an outer wall taken along the line B-B in FIG. 5 for the second example of the outer wall.

FIG. 12 is a cross-sectional view of an outer wall illustrating a fixing structure of a support member in the second example of the outer wall.

FIG. 13 is a cross-sectional view of an outer wall illustrating an arrangement relationship between the support member and an outer thermal insulating material in the second example of the outer wall.

### DESCRIPTION OF EMBODIMENTS

### Building

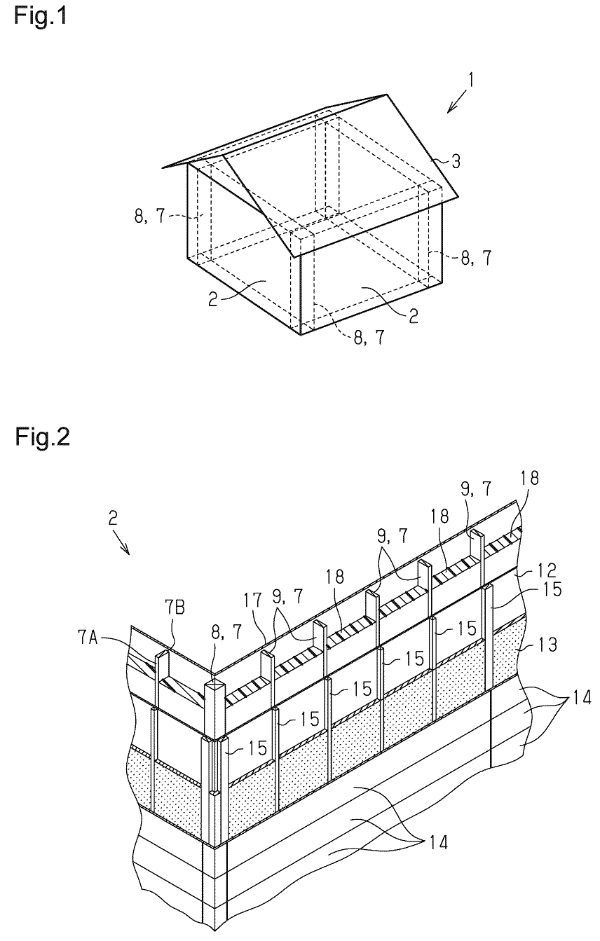

As illustrated in FIG. 1, a building 1 includes an outer wall 2. Preferably, the building 1 includes a roof 3. The building 1 has an indoor space surrounded by the outer wall 2 and the roof 3. Examples of the building 1 include facilities such as a house, a store, a community center, and a hospital.

### Outer Wall of Building

As illustrated in FIG. 2, the outer wall 2 includes multiple vertical frames 7, an outer board 12, an outer thermal insulating material 13, and an outer wall panel 14.

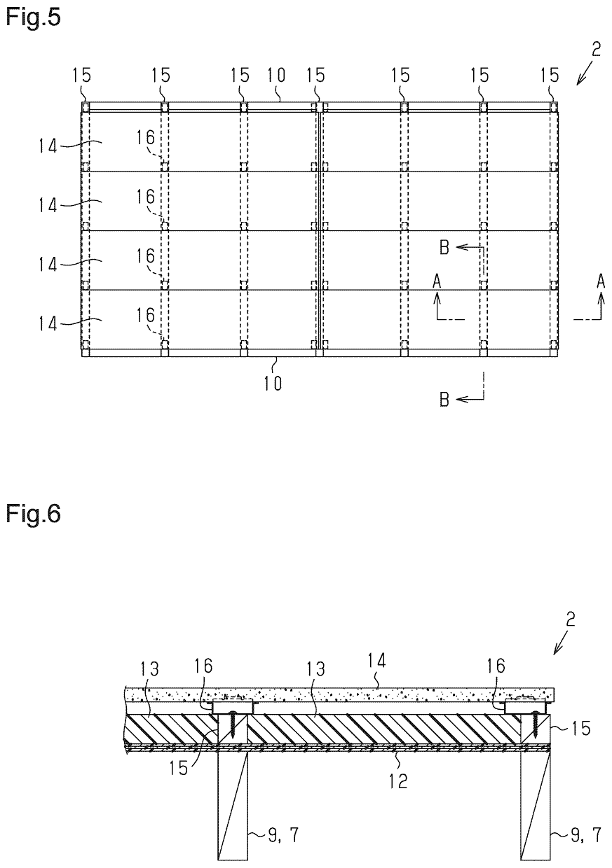

The vertical frames 7 are arranged at intervals. The vertical frames 7 are joined by horizontal frames 10 (see FIG. 5). One of the horizontal frames 10 connects the upper ends of the vertical frames 7. The other one of the horizontal frames 10 connects the lower ends of the vertical frames 7. The vertical frames 7 include columns 8 and studs 9. The studs 9 are members disposed between two of the columns 8. The columns 8 are disposed at the interior corners or the exterior corners of the building 1. Each of the columns 8 may be disposed at a predetermined position between an interior corner and an interior corner, at a predetermined position between an exterior corner and an exterior corner, or at a predetermined position between an exterior corner and an interior corner. The columns 8 and the studs 9 are made of wood.

The outer board 12 is provided on outer surfaces 7A of the vertical frames 7. The outer board 12 is made of wood. In one example, the outer board 12 is made of plywood.

The outer thermal insulating material 13 is provided on the outer surface of the outer board 12. The outer thermal insulating material 13 is made of foamed plastic. Examples of the foamed plastic include polystyrene foam, urethane foam, polystyrene foam, and phenol foam.

The outer wall panel 14 is provided on the vertical frames 7 with at least one support member 15 between the outer wall panel 14 and the vertical frames 7. Examples of the outer wall panels 14 include ALC panels, ceramic-based siding boards, metal-based siding boards, and wooden boards. ALC panels are panels obtained by curing lightweight aerated concrete panels with high-temperature and high-pressure steam.

The outer wall panel 14 has an upper end 21 and a lower end 22. In one example, the upper end 21 of the outer wall panel 14 is configured to overlap the lower end 22 of another outer wall panel 14 (see, FIG. 4). When two outer wall panels 14 are disposed one above the other, the lower end 22 of the upper outer wall panel 14 is configured to be disposed in front of the upper end 21 of the lower outer wall panel 14.

As illustrated in FIG. 4, in one example, the lower end 22 of the outer wall panel 14 has a first step 22A. The first step 22A is formed by cutting out the corner between a back surface 14B and the lower end surface of the lower end 22 of the outer wall panel 14.

The upper end 21 of the outer wall panel 14 has a second step 21A. The second step 21A is configured by cutting out a corner between a front surface 14A and the upper end surface of the upper end 21 of the outer wall panel 14. A tip 21B of the upper end 21 includes the tip portion of the second step 21A.

The outer wall panel 14 has a structure that engages with a support bracket 16.

A recess 22C is provided in the first step 22A of the lower end 22 of the outer wall panel 14. The recess 22C is recessed upward from a step surface 22B of the first step 22A. The recess 22C is configured to receive a first extending portion 35B of a first hook 35 of the support bracket 16.

A flat portion 21C parallel to the back surface 14B is provided at the tip 21B of the upper end 21 of the outer wall panel 14. The flat portion 21C is provided in the second step 21A. The tip 21B is configured such that a second hook 36 of the support bracket 16 is engaged.

As illustrated in FIG. 2, preferably the outer wall 2 includes an inner board 17 and an inner thermal insulating material 18. The inner board 17 is provided on the inner surfaces 7B of the vertical frames 7. The inner board 17 is formed by wooden panels, plastic panels, or refractory boards. Examples of the refractory boards include plasterboards.

The inner thermal insulating material 18 is provided between the inner board 17 and the outer board 12. The inner thermal insulating material 18 is made of glass wool, rock wool, or foamed plastic. Examples of the foamed plastic include polystyrene foam, urethane foam, polystyrene foam, and phenol foam.

The support member 15 is made of wood. The support member 15 is configured to extend along the vertical frame 7. Specifically, the support member 15 extends vertically along the column 8 or the stud 9. The support member 15 is fixed to the vertical frame 7 with the outer board 12 between the support member 15 and the vertical frame 7.

For example, the support member 15 is fixed to the column 8 or the stud 9 with the outer board 12 between the support member 15 and the column 8 or the stud 9 (see FIG. 8). In other examples, the support member 15 is fixed to the column 8 or the stud 9 with the outer board 12 and the outer thermal insulating material 13 between the support member 15 and the column 8 (see FIG. 12). The support member 15 is fixed to the column 8 or the stud 9 with a screw 40 or a bolt.

As illustrated in FIG. 2, the outer wall panel 14 is disposed so as to extend over the multiple support members 15 disposed at intervals. The outer wall panel 14 is supported by the support brackets 16 respectively provided on the support members 15. The outer wall panel 14 is supported by the support bracket 16 that engages with the upper end 21 of the outer wall panel 14 and the support bracket 16 that supports the lower end 22 of the outer wall panel 14.

### Support Bracket

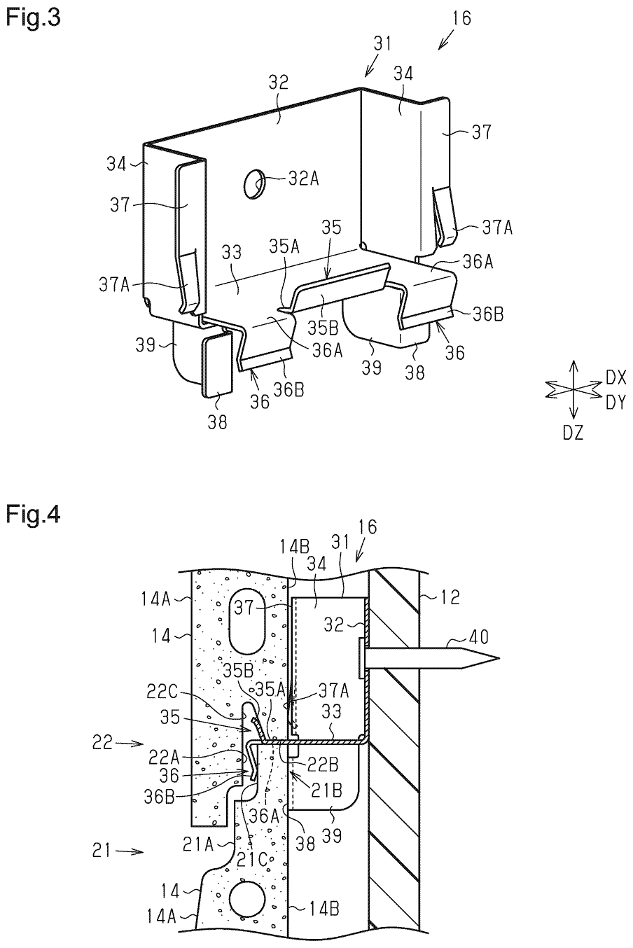

An example of the support bracket 16 will be described with reference to FIGS. 3 and 4. In the description of the support bracket 16, a front-back direction DY is defined as a direction perpendicular to a back surface 32. The front side is defined as a direction from the back surface 32 toward the outer wall panel 14 in the fixed state of the support bracket 16. A lateral direction DX is defined as a direction orthogonal to the front-back direction DY and a vertical direction DZ in the fixed state of the support bracket 16.

The support bracket 16 supports the outer wall panel 14.

The support bracket 16 includes a bracket main body 31 and at least one of the first hook 35 and the second hook 36. The description “at least one of A and B” in the present specification should be understood as meaning “only A, or only B, or both A and B”.

The support bracket 16 having the first hook 35 and the second hook 36 is disposed between two outer wall panels 14 disposed vertically. The first hook 35 of the support bracket 16 supports the upper outer wall panel 14 of the two outer wall panels 14. The second hook 36 of the support bracket 16 engages with the lower outer wall panel 14 of the two outer wall panels 14.

The support bracket 16 having only the first hook 35 supports the outer wall panel 14 disposed at the lowermost position among the multiple outer wall panels 14. The support bracket 16 having only the second hook 36 engages with the uppermost outer wall panel 14 among the multiple outer wall panels 14.

The bracket main body 31 includes the back surface 32, a bottom surface 33, and two side surfaces 34. Each of the side surfaces 34 are provided on the opposite ends of the back surface 32. The back surface 32 has an insertion hole 32A. The insertion hole 32A is configured such that the screw 40 or a bolt passes through the insertion hole 32A. The support bracket 16 is fixed to the support member 15 by driving the screw 40 or a bolt into the insertion hole 32A in a state in which the back surface 32 is pressed against the support member 15.

The first hook 35 engages with the lower end 22 of the outer wall panel 14 and supports the outer wall panel 14. The first hook 35 includes a first protruding portion 35A protruding from the front end of the bottom surface 33 of the bracket main body 31 and the first extending portion 35B extending upward from the tip of the first protruding portion 35A. The first protruding portion 35A is configured to receive the lower end 22 of the outer wall panel 14. The first extending portion 35B is configured to enter the recess 22C of the outer wall panel 14.

The second hook 36 is engaged with the tip 21B of the upper end 21 of the outer wall panel 14. The second hook 36 is engaged with the tip 21B of the upper end 21 of the outer wall panel 14, thereby preventing the outer wall panel 14 from falling forward.

The second hook 36 has a second protruding portion 36A protruding from the front end of the bottom surface 33 of the bracket main body 31 and a second extension portion 36B extending downward from the tip of the second protruding portion 36A. The second protruding portion 36A is configured to be disposed on the upper end 21 of the outer wall panel 14. The second extension portion 36B is configured to be contactable with the flat portion 21C of the upper end 21 of the outer wall panel 14.

The support bracket 16 further includes two first pressing portions 37 and two second pressing portions 38. The first pressing portion 37 extends in the lateral direction DX from the front end of the side surface 34 of the bracket main body 31. The first pressing portion 37 includes a plate spring 37A. The plate spring 37A protrudes forward. The first pressing portion 37 is in contact with the back surface 14B of the upper outer wall panel 14 of the two outer wall panels 14 arranged vertically. The plate spring 37A of the first pressing portion 37 and the first extending portion 35B of the first hook 35 sandwich a part of the lower end 22 of the outer wall panel 14.

The second pressing portion 38 is connected to the side end of the bottom surface 33 with a bent portion 39 between the second pressing portion 38 and the side end.

The second pressing portion 38 is in contact with the back surface 14B of the lower outer wall panel 14 of the two outer wall panels 14 arranged vertically. The second pressing portion 38 and the second extension portion 36B of the second hook 36 sandwich the tip 21B of the upper end portion 21 of the outer wall panel 14.

### First Example of Outer Wall Structure

A first example of the outer wall structure will be described with reference to FIGS. 5 to 9. The outer wall 2 includes the vertical frames 7, the inner board 17, the outer board 12, the inner thermal insulating material 18, the outer thermal insulating material 13, the outer wall panel 14, and the support member 15. In FIGS. 6 to 9, the inner board 17 and the inner thermal insulating material 18 are not illustrated.

As illustrated in FIGS. 5 and 6, the support member 15 is provided on each of the vertical frames 7.

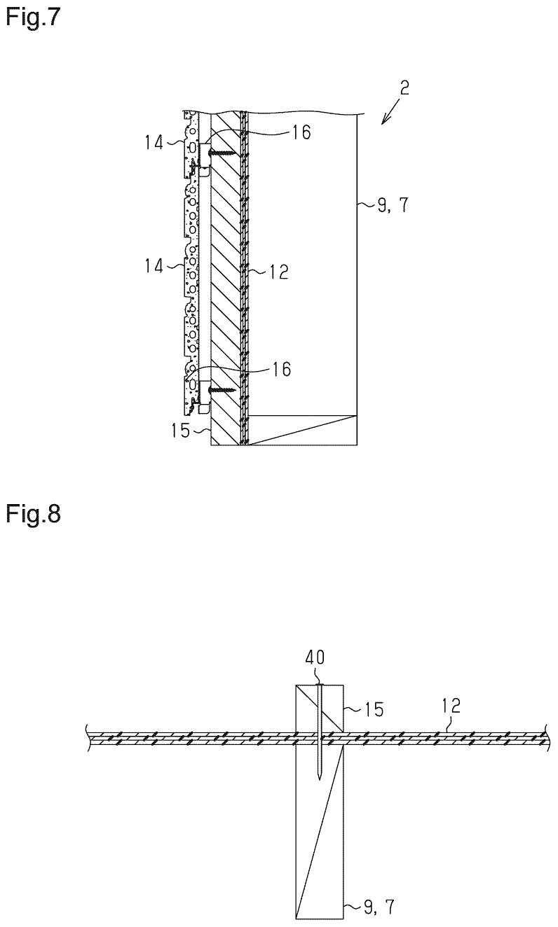

As illustrated in FIGS. 6 and 7, the support member 15 is fixed along the vertical frame 7 with the outer board 12 between the support member 15 and the vertical frame 7. Specifically, the support member 15 extends along the column 8 or the stud 9.

As illustrated in FIG. 8, the support member 15 is fixed to the vertical frame 7 with the screw 40 or a bolt. In the example of FIG. 8, the screw 40 pierces the vertical frame 7 through the support member 15 and the outer board 12.

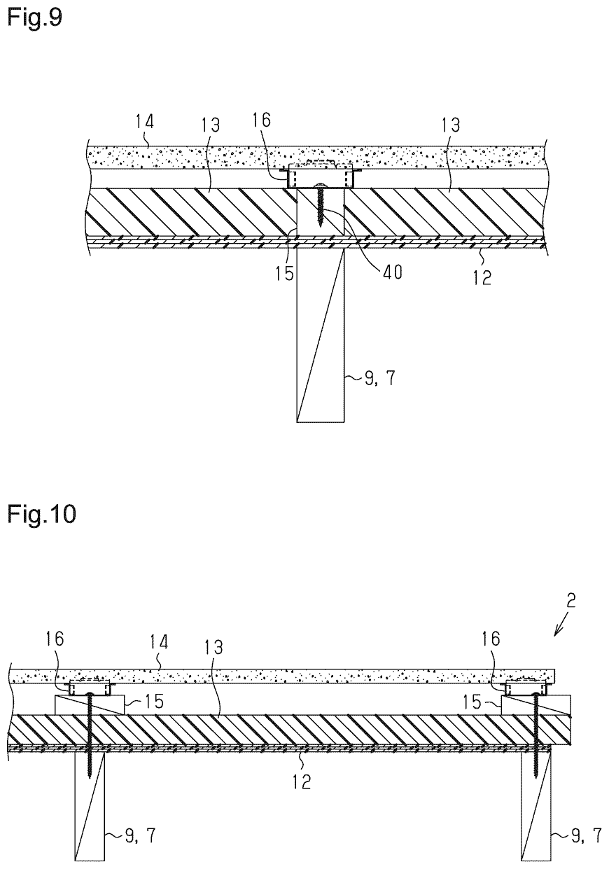

As illustrated in FIG. 9, the outer thermal insulating material 13 is disposed adjacent to the support member 15. Specifically, the outer thermal insulating material 13 is disposed between the support members 15 disposed at intervals. The thickness of the outer thermal insulating material 13 is less than or equal to the thickness of the support member 15.

Operation of the first example of the outer wall 2 will be described.

When the support member 15 is provided in the intermediate portion between vertical frames 7 on the outer board 12, the load of the outer wall panel 14 is applied to the intermediate portion of the outer board 12. Then, the outer board 12 may be gradually deformed by the load of the outer wall panel 14. In this regard, in the present embodiment, the support member 15 is fixed along the vertical frame 7. The load of the outer wall panel 14 is directly transmitted to the vertical frame 7 via the support bracket 16 and the support member 15. As a result, deformation of the outer board 12 is reduced.

### Second Example of Outer Wall Structure

A second example of the outer wall structure will be described with reference to FIGS. 5 and 10 to 13. An outer wall 2 includes multiple vertical frames 7, an inner board 17, an outer board 12, an inner thermal insulating material 18, an outer thermal insulating material 13, an outer wall panel 14, and a support member 15. In FIGS. 10 to 13, the inner board 17 and the inner thermal insulating material 18 are not illustrated.

As illustrated in FIGS. 5 and 10, the support member 15 is provided on each of the vertical frames 7. Specifically, the support member 15 extends along the column 8 or the stud 9.

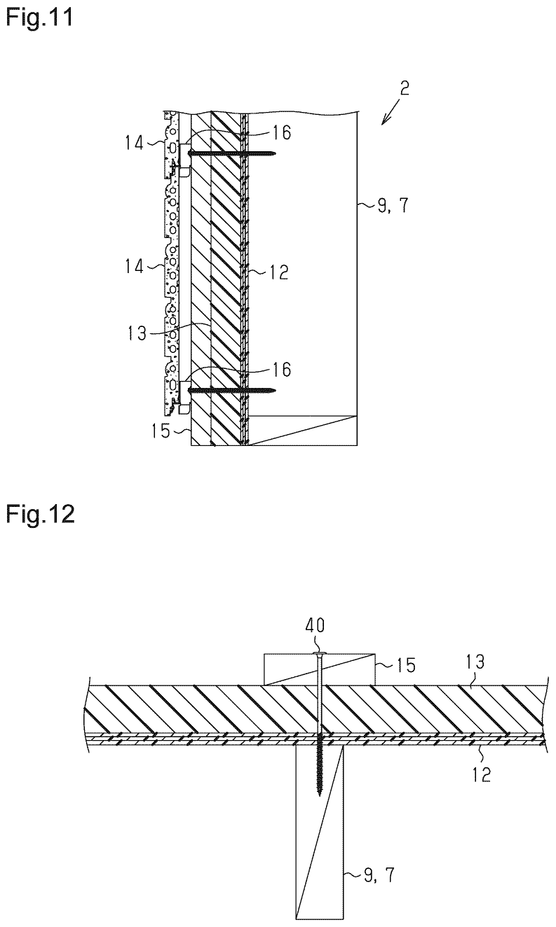

As illustrated in FIGS. 10 and 11, the support member 15 is fixed along the vertical frame 7 with the outer board 12 and the outer thermal insulating material 13 between the support member 15 and the vertical frame 7.

As illustrated in FIG. 12, the support member 15 is fixed to the vertical frame 7 with the screw 40 or a bolt. In the example of FIG. 12, the screw 40 pierces the vertical frame 7 through the support member 15, the outer thermal insulating material 13, and the outer board 12.

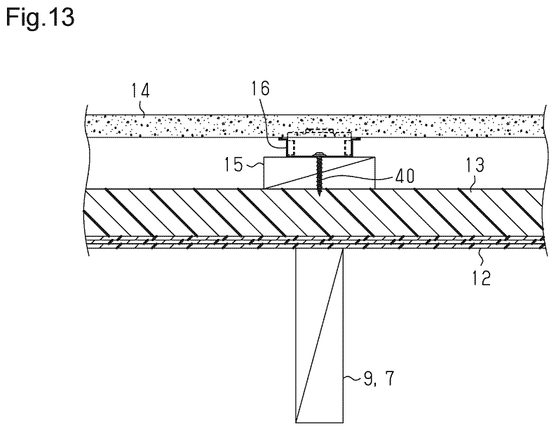

As illustrated in FIG. 13, the support bracket 16 is fixed to the support member 15 with the screw 40 or a bolt. The screw 40 or a bolt for fixing the support bracket 16 is driven in the support member 15 so as not to penetrate through the outer thermal insulating material 13.

As illustrated in FIG. 13, the outer thermal insulating material 13 is provided so as to be in contact with the outer board 12. The outer thermal insulating material 13 is provided over the entire outer board 12 so as to be present both in areas corresponding to the vertical frames 7 and in areas not corresponding to the vertical frames 7 when viewed from the front. That is, the side surface of the outer wall 2 is covered with the outer thermal insulating material 13 without any gap.

Operation of the second example of the outer wall 2 will be described.

When the support member 15 is provided in the intermediate portion between vertical frames 7 on the outer board 12, the load of the outer wall panel 14 is applied to the intermediate portion of the outer board 12. Then, the outer board 12 may be gradually deformed by the load of the outer wall panel 14. In this regard, in the present embodiment, the support member 15 is fixed along the vertical frame 7. The load of the outer wall panel 14 is directly transmitted to the vertical frame 7 via the support bracket 16 and the support member 15. As a result, deformation of the outer board 12 is reduced.

In addition, the outer thermal insulating material 13 covers the entire outer board 12. The support member 15 is fixed to the vertical frame 7 with the outer board 12 and the outer thermal insulating material 13 between the support member 15 and the vertical frame 7. With such a structure, a continuous outer thermal insulation layer having a small gap is formed.

Advantages of the embodiment will now be described.

(1) The outer wall 2 includes the multiple vertical frames 7, the outer board 12, the outer thermal insulating material 13 provided on the outer face of the outer board 12 and the outer wall panel 14 provided on the vertical frames 7 with at least one support member 15 between the outer wall panel 14 and the vertical frames 7. The support member 15 is fixed to the vertical frame 7 with the outer board 12 between the support member 15 and the vertical frames 7. The outer wall panel 14 is fixed to the support member 15 with the support bracket 16 between the outer wall panel 14 and the support member 15. According to this configuration, the support member 15 is fixed to the vertical frame 7. As a result, the outer wall 2 is less likely to deteriorate. In addition, since the vertical frame 7 is reinforced by the support member 15, deterioration of the building 1 is suppressed.

(2) The outer wall 2 may include the inner board 17 and the inner thermal insulating material 18 provided between the inner board 17 and the outer board 12. According to this configuration, the thermal insulating properties of the outer wall 2 are improved by the inner thermal insulating material 18.

(3) The support member 15 is configured to extend along the vertical frame 7. According to this configuration, the vertical frame 7 is reinforced.

(4) In the outer wall 2 of the first example, the support member 15 is fixed along the vertical frame 7 with the outer board 12 between the support member 15 and the vertical frame 7. The outer thermal insulating material 13 is disposed between the support members 15 disposed at intervals similarly to the vertical frames 7. According to this configuration, the support member 15 is firmly fixed to the vertical frame 7.

(5) In the outer wall 2 of the second example, the outer thermal insulating material 13 is provided so as to be in contact with the outer board 12. The support member 15 is fixed to the vertical frame 7 with the outer board 12 and the outer thermal insulating material 13 between the support member 15 and the vertical frame 7. According to this configuration, the thermal insulation layer having a small gap is formed by the outer thermal insulating material 13. Therefore, the thermal insulating properties of the outer wall 2 are improved.

(6) In the outer wall 2, the support member 15 is provided on each of the vertical frames 7. The outer wall panel 14 is disposed so as to extend over the multiple support members 15 disposed at intervals. The outer wall panel 14 is supported by the support brackets 16 provided on each of the support members 15. Preferably, the outer wall panel 14 is disposed so as to extend over three or more support members 15, and is supported by the support brackets 16 respectively provided on the support members 15. According to this configuration, the support of the outer wall panel 14 is stabilized.

(7) The building 1 includes any of the outer walls 2 described above. According to this configuration, the building 1 has an outer wall 2 that resists deterioration. Therefore, it is possible to provide a building 1 that has the thermal insulating properties and resists deterioration.

### Modifications

The above embodiment is an example of a form that can be taken by the building 1 and the outer wall 2, and is not intended to limit the forms thereof. The building 1 and the outer wall 2 can take forms different from those exemplified in the above embodiment. Examples include forms in which parts of the configuration of the embodiment are replaced, changed, or omitted, or forms in which new configurations are added to the embodiment. Modifications of the embodiment will be described below.

The engagement structure between the outer wall panel 14 and the support bracket 16 is not limited to the example of the embodiment. For example, when the outer wall panel 14 has a groove on the back surface 14B, the support bracket 16 may have a protrusion that enters the groove. The outer wall panel 14 is hung on a protrusion of the support bracket 16.

The support members 15 does not necessarily need to be provided on a one-to-one basis for all of the vertical frames 7 forming the outer wall 2. For example, in a case in which the outer wall 2 includes two columns 8 and three studs 9, the support members 15 may be provided only on the two columns 8 and one of the studs 9.

### REFERENCE SIGNS LIST

1 Building

2 Outer Wall

7 Vertical Frame

7A Outer Surface

7B Inner Surface

12 Outer Board

13 Outer Thermal Insulating Material

14 Outer Wall Panel

15 Support Member

16 Support Bracket

17 Inner Board

18 Inner Thermal Insulating Material

1. An outer wall of a building, comprising:
multiple vertical frames arranged at intervals;
an outer board provided on outer surfaces of the vertical frames;
an outer thermal insulating material provided on an outer surface of the outer board; and
an outer wall panel provided on the vertical frame with at least one support member between the outer wall panel and the vertical frame, wherein
the support member is fixed to the vertical frame with the outer board between the support member and the vertical frame, and
the outer wall panel is fixed to the support member with a support bracket.

2. The outer wall according to claim 1, further comprising:
an inner board provided on inner surfaces of the vertical frames; and
an inner thermal insulating material provided between the inner board and the outer board.

3. The outer wall according to claim 1, wherein the support member extends along the vertical frame.

4. The outer wall according to claim 3, wherein
the support member is fixed along the vertical frame with the outer board between the support member and the vertical frame, and
the outer thermal insulating material is disposed between the support members which are disposed at intervals.

5. The outer wall according to claim 3, wherein
the outer thermal insulating material is provided so as to be in contact with the outer board, and
the support member is fixed to the vertical frame with the outer board and the outer thermal insulating material between the support member and vertical frame.

6. The outer wall according to claim 3, wherein
the support member is provided on each of the vertical frames, and
the outer wall panel is disposed so as to extend over the support members disposed at intervals, and is supported by the support brackets respectively provided on the support members.

7. A building comprising the outer wall according to claim 1.
